(19) United States
(12) Patent Application Publication
(10) Pub. No.: US 2024/0023139 A1
(43) Pub. Date: Jan. 18, 2024

(54) SIDELINK RETRANSMISSION FOR BROADCAST DATA

(71) Applicant: QUALCOMM INCORPORATED, San Diego, CA (US)

(72) Inventors: Kangqi LIU, San Diego, CA (US); Ruiming ZHENG, Beijing (CN); Changlong XU, Beijing (CN); Liangming WU, Beijing (CN); Jian LI, Shanghai (CN); Kexin XIAO, Shanghai (CN); Hao XU, Beijing (CN); Wei LIU, Beijing (CN)

(21) Appl. No.: 18/256,621

(22) PCT Filed: Feb. 2, 2021
(86) PCT No.: PCT/CN2021/074813

§ 371 Date: Jun. 8, 2023

(51) Int. Cl. H04W 72/25; H04L 1/00

(52) U.S. Cl. CPC H04W 72/25; H04L 1/0076; H04L 2001/0097

(57) ABSTRACT

Methods, systems, and devices for wireless communications are described. A user equipment (UE) may receive, from a base station, encoded packets that are encoded using network coding. The encoded packets may be associated with source packets that represent a data set. The UE may attempt to recover the source packets from the encoded packets received from the base station. Upon failing to recover the source packets, the UE may transmit, over a sidelink channel, a message requesting sidelink assistance in recovering the source packets.

### CROSS REFERENCE

The present Application is a 371 national stage filing of International PCT Application No. PCT/CN2021/074813 by LIU et al. entitled “SIDELINK RETRANSMISSION FOR BROADCAST DATA,” filed Feb. 2, 2021, which is assigned to the assignee hereof, and which is expressly incorporated by reference in its entirety herein.

### FIELD OF TECHNOLOGY

The following relates to wireless communications, including sidelink retransmission for broadcast data.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some examples, a UE may fail to recover data broadcast by a base station. Improved re-transmission techniques for recovering broadcast data may be desired.

### SUMMARY

The described techniques relate to improved methods, systems, devices, and apparatuses that support sidelink retransmission for broadcast data. A user equipment (UE) may receive a set of encoded packets in a broadcast from a base station. The encoded packets may be encoded using network coding at the base station. Upon determining that the UE is unable to recover the source packets associated with the set of encoded packets, the UE may transmit—to one or more UEs over a sidelink channel—a request for assistance recovering the source packets. Based on transmitting the request, the UE may receive encoded packets from the one or more UEs and use those encoded packets to recover the source packets.

A method for wireless communication at a UE is described. The method may include receiving, as a broadcast from a base station, a set of multiple encoded packets associated with a set of multiple source packets representing a data set, attempting to recover the set of multiple source packets from the set of multiple encoded packets received from the base station, and transmitting, to a second UE over a sidelink channel and based on failure by the UE to recover the set of multiple source packets representing the data set, a message requesting sidelink assistance in recovering the set of multiple source packets representing the data set.

An apparatus for wireless communication at a UE is described. The apparatus may include a processor, memory coupled with the processor, and instructions stored in the memory. The instructions may be executable by the processor to cause the apparatus to receive, as a broadcast from a base station, a set of multiple encoded packets associated with a set of multiple source packets representing a data set, attempt to recover the set of multiple source packets from the set of multiple encoded packets received from the base station, and transmit, to a second UE over a sidelink channel and based on failure by the UE to recover the set of multiple source packets representing the data set, a message requesting sidelink assistance in recovering the set of multiple source packets representing the data set.

Another apparatus for wireless communication at a UE is described. The apparatus may include means for receiving, as a broadcast from a base station, a set of multiple encoded packets associated with a set of multiple source packets representing a data set, means for attempting to recover the set of multiple source packets from the set of multiple encoded packets received from the base station, and means for transmitting, to a second UE over a sidelink channel and based on failure by the UE to recover the set of multiple source packets representing the data set, a message requesting sidelink assistance in recovering the set of multiple source packets representing the data set.

A non-transitory computer-readable medium storing code for wireless communication at a UE is described. The code may include instructions executable by a processor to receive, as a broadcast from a base station, a set of multiple encoded packets associated with a set of multiple source packets representing a data set, attempt to recover the set of multiple source packets from the set of multiple encoded packets received from the base station, and transmit, to a second UE over a sidelink channel and based on failure by the UE to recover the set of multiple source packets representing the data set, a message requesting sidelink assistance in recovering the set of multiple source packets representing the data set.

Some examples of the method, apparatuses, and non-transitory computer-readable medium described herein may further include operations, features, means, or instructions for determining that the UE may have failed to recover one or more encoded packets of the set of multiple encoded packets and including, in the message, a request for the one or more encoded packets.

Some examples of the method, apparatuses, and non-transitory computer-readable medium described herein may further include operations, features, means, or instructions for including, in the message, an index associated with the data set and one or more indices corresponding to the one or more encoded packets.

Some examples of the method, apparatuses, and non-transitory computer-readable medium described herein may further include operations, features, means, or instructions for including, in the message, an index associated with the data set and a request for a quantity of encoded packets for recovering the set of multiple source packets.

In some examples of the method, apparatuses, and non-transitory computer-readable medium described herein, the message includes a network coding layer report associated with a network coding layer between a packet data convergence protocol layer and a radio link control layer.

Some examples of the method, apparatuses, and non-transitory computer-readable medium described herein may further include operations, features, means, or instructions for receiving, from the second UE responsive to the message, one or more encoded packets associated with the set of multiple source packets and recovering the set of multiple source packets based on receiving the one or more encoded packets.

Some examples of the method, apparatuses, and non-transitory computer-readable medium described herein may further include operations, features, means, or instructions for transmitting sidelink control information that schedules transmission, by the second UE, of the one or more encoded packets.

Some examples of the method, apparatuses, and non-transitory computer-readable medium described herein may further include operations, features, means, or instructions for receiving sidelink control information that schedules transmission, by the second UE, of the one or more encoded packets.

In some examples of the method, apparatuses, and non-transitory computer-readable medium described herein, recovering the set of multiple source packets may include operations, features, means, or instructions for decoding the set of multiple encoded packets and the one or more encoded packets at a network coding layer which may be between a packet data convergence protocol layer and radio link control layer in a protocol stack.

In some examples of the method, apparatuses, and non-transitory computer-readable medium described herein, transmitting the message requesting sidelink assistance may include operations, features, means, or instructions for transmitting the message as a unicast transmission to the second UE, receiving, from a third UE different from the second UE, responsive to the message, one or more encoded packets associated with the set of multiple source packets, and recovering the set of multiple source packets based on receiving the one or more encoded packets.

Some examples of the method, apparatuses, and non-transitory computer-readable medium described herein may further include operations, features, means, or instructions for determining a channel quality, a reference signal received power, or a combination thereof, for one or more UEs and selecting a subset of UEs from the one or more UEs to which the message may be to be transmitted based on the channel quality, the reference signal received power, or the combination thereof.

Some examples of the method, apparatuses, and non-transitory computer-readable medium described herein may further include operations, features, means, or instructions for receiving, from the second UE responsive to the message, a second message indicating that the second UE may be not able to assist the UE with recovering the set of multiple source packets.

In some examples of the method, apparatuses, and non-transitory computer-readable medium described herein, the message may be broadcast, groupcast, or unicast.

A method for wireless communication at a UE is described. The method may include receiving, as a broadcast from a base station, a set of multiple encoded packets associated with a set of multiple source packets representing a data set, receiving, from a second UE over a sidelink channel, a first message requesting sidelink assistance in recovering the set of multiple source packets, and transmitting, to the second UE responsive to the first message, a second message indicative of an ability of the UE to assist the second UE with recovering the set of multiple source packets.

An apparatus for wireless communication at a UE is described. The apparatus may include a processor, memory coupled with the processor, and instructions stored in the memory. The instructions may be executable by the processor to cause the apparatus to receive, as a broadcast from a base station, a set of multiple encoded packets associated with a set of multiple source packets representing a data set, receive, from a second UE over a sidelink channel, a first message requesting sidelink assistance in recovering the set of multiple source packets, and transmit, to the second UE responsive to the first message, a second message indicative of an ability of the UE to assist the second UE with recovering the set of multiple source packets.

Another apparatus for wireless communication at a UE is described. The apparatus may include means for receiving, as a broadcast from a base station, a set of multiple encoded packets associated with a set of multiple source packets representing a data set, means for receiving, from a second UE over a sidelink channel, a first message requesting sidelink assistance in recovering the set of multiple source packets, and means for transmitting, to the second UE responsive to the first message, a second message indicative of an ability of the UE to assist the second UE with recovering the set of multiple source packets.

A non-transitory computer-readable medium storing code for wireless communication at a UE is described. The code may include instructions executable by a processor to receive, as a broadcast from a base station, a set of multiple encoded packets associated with a set of multiple source packets representing a data set, receive, from a second UE over a sidelink channel, a first message requesting sidelink assistance in recovering the set of multiple source packets, and transmit, to the second UE responsive to the first message, a second message indicative of an ability of the UE to assist the second UE with recovering the set of multiple source packets.

In some examples of the method, apparatuses, and non-transitory computer-readable medium described herein, the first message includes a request for one or more encoded packets associated with the set of multiple source packets and the method, apparatuses, and non-transitory computer-readable medium may include further operations, features, means, or instructions for including the one or more encoded packets in the second message.

In some examples of the method, apparatuses, and non-transitory computer-readable medium described herein, the first message includes an index associated with the data set and one or more indices corresponding to the one or more encoded packets.

In some examples of the method, apparatuses, and non-transitory computer-readable medium described herein, the first message includes an index associated with the data set and a request for a quantity of encoded packets for recovering the set of multiple source packets and the method, apparatuses, and non-transitory computer-readable medium may include further operations, features, means, or instructions for including the quantity of encoded packets in the second message.

Some examples of the method, apparatuses, and non-transitory computer-readable medium described herein may further include operations, features, means, or instructions for decoding the set of multiple encoded packets at a network coding layer which may be between a packet data convergence protocol layer and radio link control layer in a protocol stack and recovering the set of multiple source packets associated with the data set based on decoding the set of multiple encoded packets.

Some examples of the method, apparatuses, and non-transitory computer-readable medium described herein may further include operations, features, means, or instructions for including, in the second message, one or more encoded packets associated with the set of multiple source packets, where the one or more encoded packets may be scheduled by sidelink control information included in the first message.

Some examples of the method, apparatuses, and non-transitory computer-readable medium described herein may further include operations, features, means, or instructions for including, in the second message, one or more encoded packets associated with the set of multiple source packets and including, in the second message, sidelink control information that schedules transmission of the one or more encoded packets.

Some examples of the method, apparatuses, and non-transitory computer-readable medium described herein may further include operations, features, means, or instructions for determining that the UE may have failed to recover the set of multiple source packets and relaying the first message to a third UE based on determining that the UE failed to recover the set of multiple source packets, where the second message includes an indication of the relay.

Some examples of the method, apparatuses, and non-transitory computer-readable medium described herein may further include operations, features, means, or instructions for receiving, from a third UE over the sidelink channel, a third message requesting sidelink assistance in recovering the set of multiple source packets, where the second message may be groupcast to the second UE and the third UE based on the third message.

A method for wireless communication at a base station is described. The method may include generating, at a network coding layer of a protocol stack, a set of multiple source packets that represent a data set, encoding the set of multiple source packets at the network coding layer using network coding, where the encoding generates a set of multiple encoded packets from the set of multiple source packets, and transmitting the set of multiple encoded packets in a broadcast.

An apparatus for wireless communication at a base station is described. The apparatus may include a processor, memory coupled with the processor, and instructions stored in the memory. The instructions may be executable by the processor to cause the apparatus to generating, at a network code layer of a protocol stack, a set of multiple source packets that represent a data set, encode the set of multiple source packets at the network coding layer using network coding, where the encoding generates a set of multiple encoded packets from the set of multiple source packets, and transmit the set of multiple encoded packets in a broadcast.

Another apparatus for wireless communication at a base station is described. The apparatus may include means for generating, at a network coding layer of a protocol stack, a set of multiple source packets that represent a data set, means for encoding the set of multiple source packets at the network coding layer using network coding, where the encoding generates a set of multiple encoded packets from the set of multiple source packets, and means for transmitting the set of multiple encoded packets in a broadcast.

A non-transitory computer-readable medium storing code for wireless communication at a base station is described. The code may include instructions executable by a processor to generating, at a network code layer of a protocol stack, a set of multiple source packets that represent a data set, encode the set of multiple source packets at the network coding layer using network coding, where the encoding generates a set of multiple encoded packets from the set of multiple source packets, and transmit the set of multiple encoded packets in a broadcast.

In some examples of the method, apparatuses, and non-transitory computer-readable medium described herein, the network coding layer may be a bottom sublayer of a packet data convergence protocol layer.

In some examples of the method, apparatuses, and non-transitory computer-readable medium described herein, the network coding layer may be a top sublayer of a radio link control layer.

In some examples of the method, apparatuses, and non-transitory computer-readable medium described herein, the network coding layer may be a layer below a packet data convergence protocol layer and above a radio link control layer.

Some examples of the method, apparatuses, and non-transitory computer-readable medium described herein may further include operations, features, means, or instructions for allocating a first set of slots in a frame for the transmission of the set of multiple encoded packets and allocating a second set of slots in the frame for a re-transmission, by a UE over a sidelink channel, of one or more encoded packets of the set of multiple encoded packets of the data set.

### BRIEF DESCRIPTION OF THE DRAWINGS

FIG. 1 illustrates an example of a wireless communications system that supports sidelink retransmission for broadcast data in accordance with aspects of the present disclosure.

FIG. 2 illustrates an example of a wireless communications system that supports sidelink retransmission for broadcast data in accordance with aspects of the present disclosure.

FIG. 3 illustrates an example of a process flow that supports sidelink retransmission for broadcast data in accordance with aspects of the present disclosure.

FIG. 4 illustrates an example of a process flow that supports sidelink retransmission for broadcast data in accordance with aspects of the present disclosure.

FIGS. 5 and 6 show block diagrams of devices that support sidelink retransmission for broadcast data in accordance with aspects of the present disclosure.

FIG. 7 shows a block diagram of a communications manager that supports sidelink retransmission for broadcast data in accordance with aspects of the present disclosure.

FIG. 8 shows a diagram of a system including a device that supports sidelink retransmission for broadcast data in accordance with aspects of the present disclosure.

FIGS. 9 and 10 show block diagrams of devices that support sidelink retransmission for broadcast data in accordance with aspects of the present disclosure.

FIG. 11 shows a block diagram of a communications manager that supports sidelink retransmission for broadcast data in accordance with aspects of the present disclosure.

FIG. 12 shows a diagram of a system including a device that supports sidelink retransmission for broadcast data in accordance with aspects of the present disclosure.

FIGS. 13 through 15 show flowcharts illustrating methods that support sidelink retransmission for broadcast data in accordance with aspects of the present disclosure.

### DETAILED DESCRIPTION

In some wireless communications systems, a base station with a data set intended for many user equipments (UEs) may broadcast the data set to the UEs over an access link between the base station and the UEs (referred to as the Uu link). If one of the UEs fails to recover the data set, the UE may send feedback to the base station indicating the failure so that the base station can re-transmit the data set to the UE. But re-transmission of a data set may delay or interrupt other transmissions from the base station, which may negatively impact system performance.

According to the techniques described herein, a UE that fails to recover a data set broadcast over the Uu link may interact with other UEs, rather than the base station, to recover the data set. For example, the UE may transmit a request for assistance with recovering the data set to one or more UEs over a sidelink (e.g., PC5) channel. If one of the other UEs has recovered the data set, that UE may transmit packets of the data set to the requesting UE so that the requesting UE can recover the data set. To enable such a re-transmission mechanism, the base station may use network coding for the initial transmission of the data set. Additionally, the UEs may use a separate network coding layer in the protocol stack which may allow the requesting UE to recover the data set even if packets of the data set are received out of order. Thus, a UE may recover a broadcast data set without assistance from the base station, which may allow the base station to continue transmitting other data without delay or interruption, thereby improving system performance.

Aspects of the disclosure are initially described in the context of a wireless communications system. Aspects of the disclosure are further described in the context of an additional wireless communications system and process flows. Aspects of the disclosure are further illustrated by and described with reference to apparatus diagrams, system diagrams, and flowcharts that relate to various aspects of a re-transmission mechanism for broadcasts.

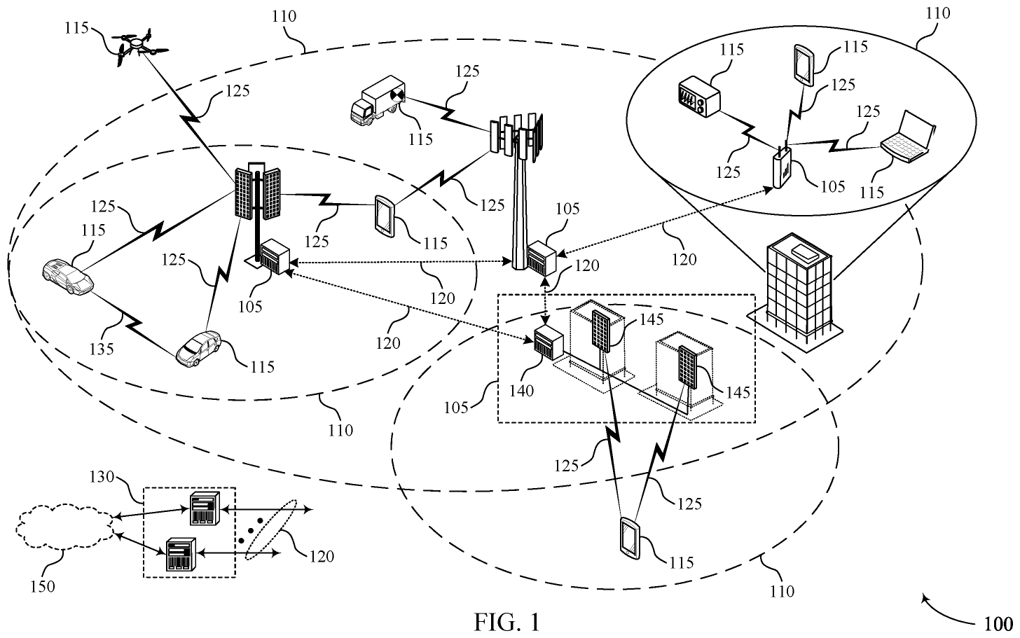

FIG. 1 illustrates an example of a wireless communications system 100 that supports sidelink retransmission for broadcast data in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a UE 115 that receives packets of a data set broadcast from a base station 105 may be unable to recover the data set. For example, the UE 115 may fail to receive and/or decode a sufficient number of packets to recover (e.g., determine accurate values for) the data set. In such a scenario, the UE 115 may transmit HARQ feedback (e.g., a negative acknowledgement (NACK)) to the base station 105 to prompt a re-transmission of the data set. But such a re-transmission may negatively impact the efficiency, latency, or both, of the wireless communications system 100, among other disadvantages. According to the techniques described herein, a UE 115 that fails to recover a broadcast data set may communicate with one or more other UEs 115, rather than the base station 105, to recover the data set. For example, the UE 115 may request (and receive) a quantity of packets (belonging to the data set) from the other UE(s) 115 so that the UE 115 can recover the data set. Relieving the base station 105 of re-retransmission responsibilities may allow the base station 105 to engage in other communications, which may improve the efficiency, latency, or both, of the wireless communications system 100, among other advantages.

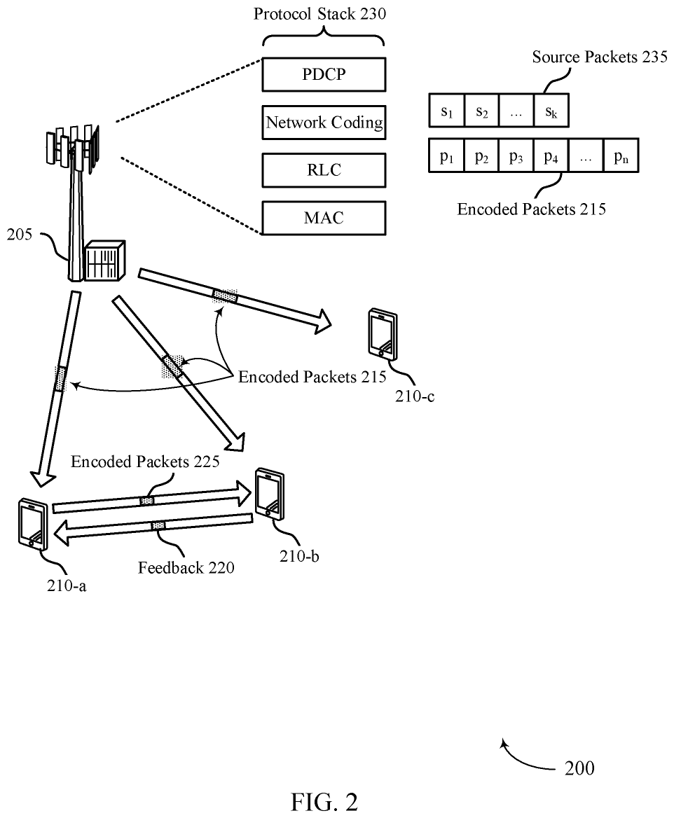

FIG. 2 illustrates an example of a wireless communications system 200 that supports sidelink retransmission for broadcast data in accordance with aspects of the present disclosure. In some examples, the wireless communications system 200 may implement aspects of the wireless communications system 100. For example, the wireless communications system 200 may include a base station 205 and UEs 210 (e.g., UE 210-a, UE 210-b, and UE 210-c), which may be examples of a base station 105 and a UE 115 as described with reference to FIG. 1. Re-transmission responsibilities for data broadcast by the base station 205 may be offloaded from the base station 205 to the UEs 210, which may improve the performance of the wireless communications system 200.

In the wireless communications system 200, one type of interface (e.g., the Uu interface) may be used for communications between the base station 205 and the UEs 210 and another type of interface (e.g., the PC5 interface) may be used for sidelink communications between the UEs 210. Sidelink communication may refer to communications between the UEs 210 that are communicated directly between the UEs 210 and are not routed through the base station 205. Thus, communications from the base station 205 to the UEs may occur over the Uu interface and sidelink communications between the UEs 210 may occur over the PC5 interface.

The base station 205 may perform a broadcast transmission over the Uu interface so that multiple UEs 210 can receive a set of data. For example, the base station 205 may broadcast encoded packets 215 (e.g., over the Uu link using the Uu interface) to the UEs 210. The encoded packets 215 may represent a data set (e.g., a sequence of bits), which may be formatted as one or more PDCP packet data units (PDUs) at the PDCP layer of the base station 205. For reasons explained below, the encoded packets 215 may be encoded using network coding (e.g., Fountain coding).

If a UE 210 fails to recover the data set (e.g., due to an insufficient quantity of received and/or decoded packets), the UE 210 may transmit to one or more of the other UEs 210 feedback that indicates the UE 210 failed to recover the data set and/or that requests assistance doing so. For example, UE 210-b may transmit feedback 220 (e.g., over a sidelink channel using the PC5 interface) to UE 210-a in a unicast, groupcast, or broadcast communication. In response to the feedback 220, UE 210-a may transmit encoded packets 225 (belonging to the data set) to UE 210-b to assist with the recovery of the data set (assuming that UE 210-a successfully recovered the data set). If UE 210-a failed to recover the data set (or is otherwise unable to assist, e.g., due to power constraints), UE 210-a may indicate to UE 210-b the inability of UE 210-a to assist with recovery of the data set.

To support recovery of the data set without re-transmitting all of the encoded packets belonging to the data set (which may be inefficient), the wireless communications system 200 may use a network code for the original transmission and the re-transmission of the data set. For example, the base station 205 may encode the data set using the network code, a process that may involve dividing the data set into source packets and applying the network code to the source packets to generate encoded packets. A network code may be an example of a Fountain code (e.g., a Luby transform (LT) code, a Raptor code) and thus may have one or more properties of a Fountain code. For example, the network code may be a rateless code (e.g., capable of producing limitless encoded packets) and may enable recovery of a data set as long as the quantity of received encoded packets is larger than the quantity of source packets regardless of which encoded packets are received. Thus, use of a network code for the data set may allow UE 210-a to efficiently assist UE 210-b with recovery of the data set by transmitting a fraction of the encoded packets belonging to the data set (as opposed to transmitting all of the encoded packets belonging to the data set, which may occur when a code other than a network code is used).

To enable recovery of the data set even if the encoded packets 225 are received out of order (e.g., with respect to some or all of the encoded packets 215), the wireless communications system 200 may employ a protocol stack 230 that includes a network coding layer. In addition to the network coding layer, the protocol stack 230 may include a PDCP layer, an RLC layer, and a MAC layer, among other layers (e.g., a physical (PHY) layer below the MAC layer). Each of the base station 205 and the UEs 210 may support a protocol stack similar to the protocol stack 230.

In a first option (Option 1), the network coding layer may be a separate (e.g., independent) layer above the RLC layer and below the PDCP layer. On the transmit side (e.g., for Option 1), the network coding layer may be responsible for receiving a PDCP PDU (which may represent a data set) from the PDCP layer. At the network coding layer, the PDCP PDU may be regarded as a network coding service data unit (SDU). The network coding layer may partition or segment the network coding SDU into k source packets and encode the k source packets to generate n encoded packets. For example, the network coding layer may partition the network coding SDU into k source packets 235 and encode the k source packets using the network code to generate n encoded packets 215. The network coding layer may then generate a network coding PDU for each of the n encoded packets (e.g., by adding a header) and communicate the network coding PDUs to the RLC layer (where the network coding PDUs may be regarded as RLC PDUs).

In some examples, the data set represented by a PDCP PDU or a network coding SDU may be identified or distinguished from other data sets using an index (e.g., the sequence number (SN) of a PDCP PDU or a network coding (NC) SDU) and the encoded packets 215 may be identified or distinguished from each other using packet indices (e.g., each encoded packet 215 may have a respective index). In some examples the encoded packet indices may be referred to as encoded symbol identifiers (ESI) or sub_SN.

In a second option (Option 2), the network coding layer may be a bottom sublayer of the PDCP layer (which may have a top PDCP layer). In a third option (Option 3), the network coding layer may be a top sublayer of the RLC layer (which may have a bottom RLC layer). In Option 2 and Option 3, the network coding SDU and the network coding PDU (as described with respect to Option 1) may not exist. For example, if the network coding layer is a bottom sublayer of the PDCP layer (as in Option 2), the functionality of the network encoding may be in the PDCP layer. So, there may be multiple PDCP PDUs related to one PDCP SDU (e.g., each PDCP PDU may be generated from one encoded packet and a header). Other configurations for the network coding layer within the protocol stack 230 are contemplated.

On the receive side, the network coding layer may be responsible for decoding encoded packets, assembling and ordering source packets, and communicating the source packets to a higher layer (e.g., the PDCP layer) for recovery of a data set. For example, in Option 1, the network coding layer may re-assemble the k source packets into a network coding SDU and then send the network coding SDU to the PDCP layer. Thus, use of a network coding layer may allow a receiving device to recover a data set even if the encoded packets belonging to the data set are received out-of-order (which may occur in the re-transmission techniques described herein). Additionally, as described above, a receiving device may recover the data set as long as the quantity of received (and decodable) encoded packets (L) is greater than the quantity of source packets (e.g., so long L is greater than k).

To support the re-transmission mechanism described herein, the base station 205 may allocate certain communication resources (e.g., time resources, frequency resources) for Uu broadcasts and other communication resources for sidelink re-transmissions associated with the Uu broadcasts. For example, the base station 205 may allocate some slots of a frame (e.g., periodically) for Uu broadcasts and other slots of the frame for sidelink re-transmissions. In some examples, the base station 205 may also allocate one or more slots of a frame for Uu feedback from the UEs 210 to the base station 205. A UE 210 may transmit to the base station 205 feedback (e.g., a NACK) for a Uu broadcast data set if the UE 210 is unable to recover the data set using the sidelink re-transmission techniques described herein.

Thus, the wireless communications system 200 may use network coding and sidelink re-transmissions to facilitate efficient recovery at a UE 210 of broadcast data set.

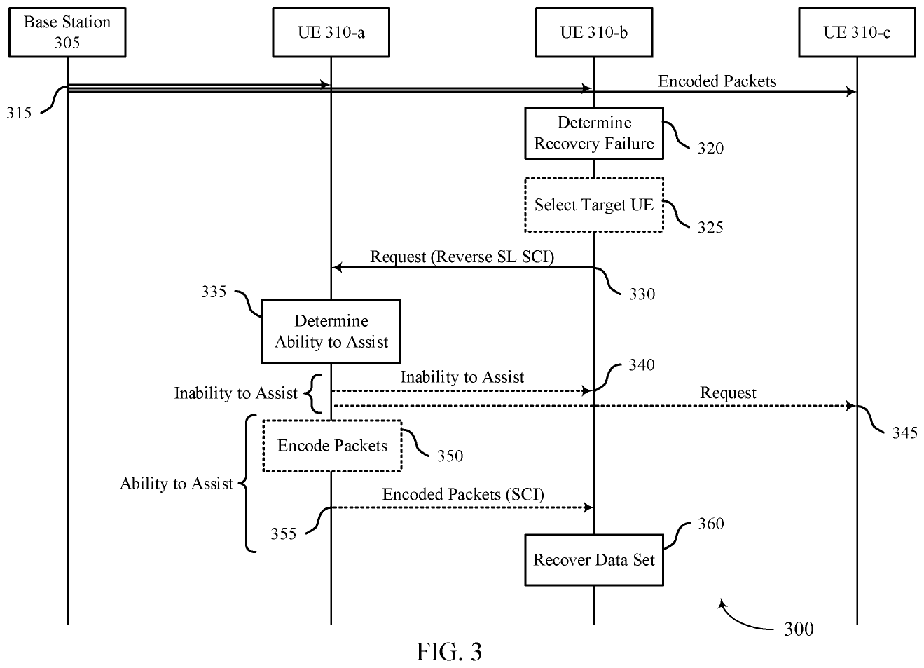

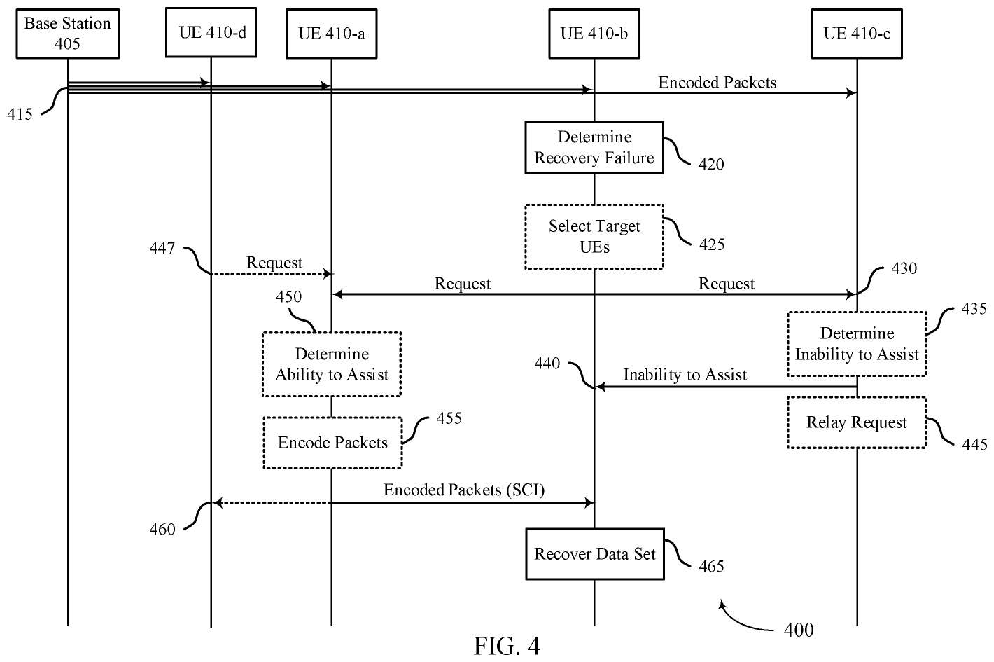

FIG. 3 illustrates an example of a process flow 300 that supports sidelink retransmission for broadcast data in accordance with aspects of the present disclosure. In some examples, the process flow 300 may implement aspects of a wireless communications system 100 or 200. For example, the process flow 300 may be implemented by a base station 305 and UEs 310, which may be examples of a base station or a UE as described herein. The process flow 300 may allow a UE 310 to efficiently recover a broadcast data set using network coding and sidelink re-transmissions. The process flow 300 may show operations when a UE transmits a unicast request for assistance with recovering a broadcast data set, whereas the process flow 400 illustrated in FIG. 4 may show operations when a UE transmits a broadcast or groupcast request for assistance with recovering a broadcast data set.

At 315, the base station 305 may transmit (e.g., as a broadcast) a data set in the form of encoded packets to the UEs 310 (e.g., UE 310-a, UE 310-b, and UE 310-c). The encoded packets may be generated from source packets belonging to the data set and using network coding as described herein. For example, the network coding layer at the base station 305 may receive the data set (e.g., in the form of a higher layer PDU), partition the data set into source packets, and encode the source packets using network coding. The network coding layer may then communicate the encoded packets (e.g., in the form of PDUs, which may each include an encoded packet plus a header) to a lower layer for additional processing before transmission. Thus, the UEs 310 may receive a set of encoded packets at 315. However, UE 310-b may not receive (or decode) enough encoded packets to recover the data set (e.g., L may be less than k, where L is the quantity of received (decodable) encoded packets and k is the quantity of source packets belonging to the data set).

At 320, UE 310-b may determine that UE 310-b failed to recover the data set (or is unable to recover the data set). For example, UE 310-b may determine that an insufficient quantity of encoded packets were received and decoded. At 325 and based on the determination at 320, UE 310-b may select a UE to which to transmit a request for assistance with recovering the data set. For example, UE 310-b may select UE 310-a. UE 310-b may select UE 310-a based on a quality of the sidelink channel between UE 310-a, based on the reference signal received power (RSRP) associated with reference signals transmitted by UE 310-b, or both, among other factors. By using channel quality and RSRP to select an assisting UE, UE 310-b may increase the reliability of the re-transmission mechanism and increase the likelihood of successfully recovering the data set.

At 330, UE 310-b may transmit (e.g., over a sidelink channel) a unicast message to UE 310-a requesting assistance with recovering the data set. Thus, the message may be indicative of the failure of UE 310-b to recover the data set.

In a first example, the message may indicate the index of the data set to be recovered and the indices of specific packets that UE 310-a is to transmit (e.g., the indices of specific packets that UE 310-b failed to recover, either due to missed reception a failure to decode). Such a technique may allow or increase combining gain at UE 310-b but may involve more control signaling overhead relative to other feedback techniques. In second example, the message may indicate the index of the data set to be recovered and a quantity of packets (e.g., x packets, where x is an integer) that UE 310-a is to transmit. The quantity of packets requested may be based on the additional quantity of packets calculated by UE 310-b for recovering the data set. Such a technique may reduce control signaling overhead but may prevent or reduce combining gain relative to other techniques.

As noted, use of network coding allows UE 310-b to recover a data set if the quantity of received/encoded packets (L) is greater than the quantity of source packets (k) belonging to the data set, even if there are N encoded packets belonging to the data set, where N is greater than L. So, for either feedback technique, the quantity of encoded packets re-transmitted may be less than the total quantity of encoded packets associated with the data set, which may improve efficiency. Additionally, control signaling may be reduced relative to other feedback techniques because the sidelink re-transmission mechanism is based on NACKs (as opposed to both NACKs and positive acknowledgements (ACKs)).

In some examples, the unicast message may include sidelink control information (SCI) that schedules transmission of the requested packets by UE 310-a. Because the SCI schedules transmission in the opposite direction of the SCI transmission, the SCI may be referred to as reverse sidelink (SL) SCI. In some examples, the unicast message may be a network coding layer message or status report that is processed by the network coding layer at UE 310-a.

At 335, based on receipt of the request at 330, UE 310-a may determine the ability of UE 310-a to assist UE 310-b with recovery of the data set. For example, UE 310-a may determine whether UE 310-a recovered the data set.

If UE 310-a determines that UE 310-a is unable to assist with recovery of the data set, UE 310-a may, at 340, transmit a message to UE 310-b indicating the inability of UE 310-a to assist. Alternatively, UE 310-a may refrain from sending SCI for a transmission of the requested packets, which UE 310-b may interpret as an implicit indication of the inability of UE 310-a to assist. In some examples, UE 310-a may also, at 345, relay the request from UE 310-b to one or more other UEs 310 (e.g., in a unicast, groupcast, or broadcast). The UE(s) selected for the relay may be based on the channel quality or other channel condition between UE 310-a and the UE(s), based on the RSRP or other power metric associated with reference signals transmitted by the UE(s), or both, among other factors. If UE 310-a relays the request at 345, UE 310-a may indicate the relay to UE 310-b so that UE 310-b is aware of the relayed request. So, UE 310-b may receive encoded packets from UE 310-c instead of UE 310-a.

If UE 310-a determines that UE 310-a is able to assist with recovery of the data set, UE 310-a may, at 350, encode the packets requested by UE 310-b. If the original encoded packets had indices up to N, the packets encoded by UE 310-b (e.g., using the network coding layer) may have indices greater than N (e.g., to prevent UE 310-b from receiving encoded packets that UE 310-b has already correctly decoded over the Uu interface). At 355, UE 310-a may transmit (e.g., over the sidelink channel) a message that includes the encoded packets. For example, the message may include the encoded packets in a physical shared sidelink channel (PSSCH). In some examples (e.g., when the message at 330 does not include reverse SL SCI), the message transmitted at 355 (or a preceding message) may include SCI that schedules the encoded packets in the PSSCH or other subchannel. The message transmitted at 355 may be indicative of the ability of UE 310-a to assist with the recovery of the data set if the message includes SCI scheduling transmission of the encoded packets or, in the absence of such SCI, if the message includes the encoded packets.

At 360, UE 310-b may recover the data set based on the encoded packets received at 355. For example, UE 310-b may determine the source packets of the data set by decoding the encoded packets received at 360 and using the decoded packets received 315. As noted, use of a network coding layer may permit UE 310-b to recover the data set even if some or all of the encoded packets received at 360 are received out of order (e.g., with respect to the encoded packets received at 315).

Thus, UE 310-b may efficiently recover a broadcast data set using network coding and sidelink re-transmissions. Because the re-transmissions are performed over the sidelink, the base station 305 may continue broadcasting (or otherwise transmitting) new data sets without the delays or interruptions associated with re-transmissions.

Alternative examples of the foregoing may be implemented, where some operations are performed in a different order than described, are performed in parallel, or are not performed at all. In some cases, operations may include additional features not mentioned below, or further operations may be added. Additionally, certain operations may be performed multiple times or certain combinations of operations may repeat or cycle.

FIG. 4 illustrates an example of a process flow 400 that supports sidelink retransmission for broadcast data in accordance with aspects of the present disclosure. In some examples, the process flow 400 may implement aspects of a wireless communications system 100 or 200. For example, the process flow 400 may be implemented by a base station 405 and UEs 410, which may be examples of a base station or a UE as described herein. The process flow 400 may allow a UE 410 to efficiently recover a broadcast data set using network coding and sidelink re-transmissions. The process flow 400 shows operations when a UE transmits a broadcast or groupcast request for assistance with recovering a broadcast data set, whereas the process flow 300 illustrated in FIG. 3 shows operations when a UE transmits a unicast request for assistance with recovering a broadcast data set. Although described separately, aspects of the process flow 300 may be combined with aspects of the process flow 400, and vice versa.

At 415, the base station 405 may transmit (e.g., as a broadcast) a data set in the form of encoded packets to the UEs 410 (e.g., UE 410-a, UE 410-b, UE 410-c, and UE 410-d). The encoded packets may be generated from source packets belonging to the data set and using network coding as described herein. For example, the network coding layer at the base station 405 may receive the data set (e.g., in the form of a higher layer PDU), partition the data set into source packets, and encode the source packets using network coding. The network coding layer may then communicate the encoded packets (e.g., in the form of PDUs, which may each include an encoded packet plus a header) to a lower layer for additional processing before transmission. Thus, the UEs 410 may receive a set of encoded packets at 415. However, UE 410-b may not receive (or decode) enough encoded packets to recover the data set (e.g., L may be less than k, where L is the quantity of received (decodable) encoded packets and k is the quantity of source packets belonging to the data set).

At 420, UE 410-b may determine that UE 410-b failed to recover the data set (or is unable to recover the data set). For example, UE 410-b may determine that an insufficient quantity of encoded packets were received and decoded. At 425 and based on the determination at 420, UE 410-b may select a group of UEs to which to transmit a groupcast request for assistance with recovering the data set. For example, UE 410-b may select UE 410-a and UE 410-c. UE 410-b may select UE 410-a and UE 410-c based on the channel qualities associated UE 410-a and UE 410-c, based on the RSRP associated with reference signals transmitted by UE 410-a and UE 410-c, or both, among other factors. By using channel quality and RSRP to select assisting UEs, UE 410-b may increase the reliability of the re-transmission mechanism and increase the likelihood of successfully recovering the data set. Alternatively, UE 410-b may conserve processing resources by opting to perform a broadcast instead of a groupcast.

At 430, UE 410-b may transmit (e.g., over a sidelink channel) a message to UE 410-a and UE 410-c requesting assistance with recovering the data set. Thus, the message may be indicative of the failure of UE 410-b to recover the data set. The message may be a broadcast message (e.g., to nearby UEs) or a groupcast message (e.g., to a subset of nearby UEs). In some examples, the message may indicate the index of the data set to be recovered and the indices of specific packets that the recipient UEs are to transmit (e.g., the indices of specific packets that UE 410-b failed to recover, either due to missed reception a failure to decode). In some examples, the message may indicate the index of the data set to be recovered and a quantity of packets (e.g., x packets, where x is an integer) that UE 410-a is to transmit. The quantity of packets requested may be based on the additional quantity of packets calculated by UE 410-b for recovering the data set. As noted, use of network coding allows UE 340-b to recover the data set if the quantity of received/encoded packets (L) is greater than the quantity of source packets (k) belonging to the data set, even if there are N encoded packets belonging to the data set, where N is greater than L). In some examples, the unicast message may be a network coding layer message that is processed by the network coding layer at UE 410-a.

At 435, based on receipt of the request at 430, UE 410-c may determine that UE 410-c does not have the ability to assist UE 410-b with recovery of the data set. For example, UE 410-c may determine that UE 410-c has failed to recover the data set. At 440, UE 410-c may transmit a message indicating the inability of UE 410-c to assist. Alternatively, UE 410-c may refrain from sending SCI for a transmission of the requested packets, which UE 410-b may interpret as an implicit indication of the inability of UE 410-c to assist. In some examples, UE 410-c may also, at 445, relay the request from UE 410-b to one or more other UEs (e.g., in a unicast, groupcast, or broadcast). The UE(s) selected for the relay may be based on the channel quality or other channel condition between UE 410-c and the UE(s), based on the RSRP or other power metric associated with reference signals transmitted by the UE(s), or both, among other factors. If UE 410-c relays the request at 445, UE 410-c may indicate the relay to UE 410-b so that UE 410-b is aware that the request was relayed.

At 450, based on receipt of the request at 430, UE 410-a may determine that UE 410-a has the ability to assist UE 410-b with recovery of the data set. For example, UE 410-a may determine that UE 410-a recovered the data set.

At 455, UE 410-a may encode the packets requested by UE 410-b. If the original encoded packets had indices up to N, the packets encoded by UE 410-b (e.g., using the network coding layer) may have indices greater than N (e.g., to prevent t UE 410-b from receiving encoded packets that UE 410-b has already correctly decoded over the Uu interface). At 460, UE 410-a may transmit (e.g., over the sidelink channel) a message that includes the encoded packets. For example, the message may include the encoded packets in a PSSCH. In some examples, the message transmitted at 460 (or a preceding message) may include SCI (e.g., SCI 1, SCI 2) that schedules the encoded packets in the PSSCH or other subchannel.

At 465, UE 410-b may recover the data set based on the encoded packets received at 460. For example, UE 410-b may determine the source packets of the data set by decoding the encoded packets received at 460 and using the decoded packets received 415. As noted, use of a network coding layer may permit UE 410-b to recover the data set even if some or all of the encoded packets received at 460 are received out of order (e.g., with respect to the encoded packets received at 415). In some examples, UE 410-b may recover the data set based on encoded packets received from UE 410-c (e.g., if UE 410-c is able to assist UE 410-b) or one or more other UEs (e.g., UEs that received the relayed request from UE 410-c).

In some examples, UE 410-a may receive multiple requests for assistance with recovering the same data set. For example, in addition to the request received at 430, UE 410-a may receive, at 447, a second request for assistance from another UE (e.g., UE 410-d). In such a scenario, UE 410-a may transmit the message at 460 as a groupcast to the UEs that requested assistance. For example, UE 410-a may transmit the message at 460 to UE 410-b and UE 410-d.

Thus, UE 410-b may efficiently recover a broadcast data set using network coding and sidelink re-transmissions. Because the re-transmissions are performed over the sidelink, the base station 405 may continue broadcasting (or otherwise transmitting) new data sets without the delays or interruptions associated with re-transmissions.

Alternative examples of the foregoing may be implemented, where some operations are performed in a different order than described, are performed in parallel, or are not performed at all. In some cases, operations may include additional features not mentioned below, or further operations may be added. Additionally, certain operations may be performed multiple times or certain combinations of operations may repeat or cycle.

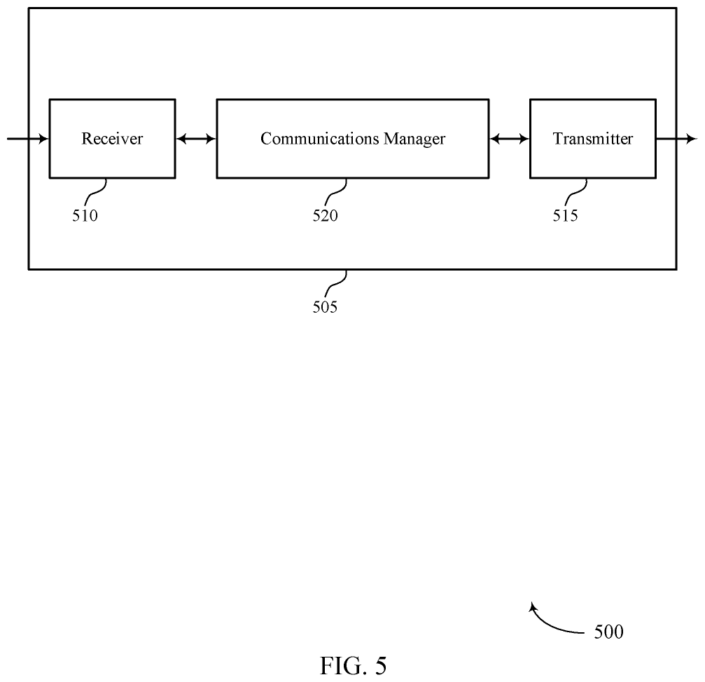

FIG. 5 shows a block diagram 500 of a device 505 that supports sidelink retransmission for broadcast data in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to sidelink retransmission for broadcast data). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to sidelink retransmission for broadcast data). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of sidelink retransmission for broadcast data as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for receiving, as a broadcast from a base station, a set of multiple encoded packets associated with a set of multiple source packets representing a data set. The communications manager 520 may be configured as or otherwise support a means for attempting to recover the set of multiple source packets from the set of multiple encoded packets received from the base station. The communications manager 520 may be configured as or otherwise support a means for transmitting, to a second UE over a sidelink channel and based on failure by the UE to recover the set of multiple source packets representing the data set, a message requesting sidelink assistance in recovering the set of multiple source packets representing the data set.

Additionally or alternatively, the communications manager 520 may support wireless communication at a UE in accordance with examples as disclosed herein. For example, the communications manager 520 may be configured as or otherwise support a means for receiving, as a broadcast from a base station, a set of multiple encoded packets associated with a set of multiple source packets representing a data set. The communications manager 520 may be configured as or otherwise support a means for receiving, from a second UE over a sidelink channel, a first message requesting sidelink assistance in recovering the set of multiple source packets. The communications manager 520 may be configured as or otherwise support a means for transmitting, to the second UE responsive to the first message, a second message indicative of an ability of the UE to assist the second UE with recovering the set of multiple source packets.

By including or configuring the communications manager 520 in accordance with examples as described herein, the device 505 (e.g., a processor controlling or otherwise coupled to the receiver 510, the transmitter 515, the communications manager 520, or a combination thereof) may support efficient recovery of data broadcast by a base station.

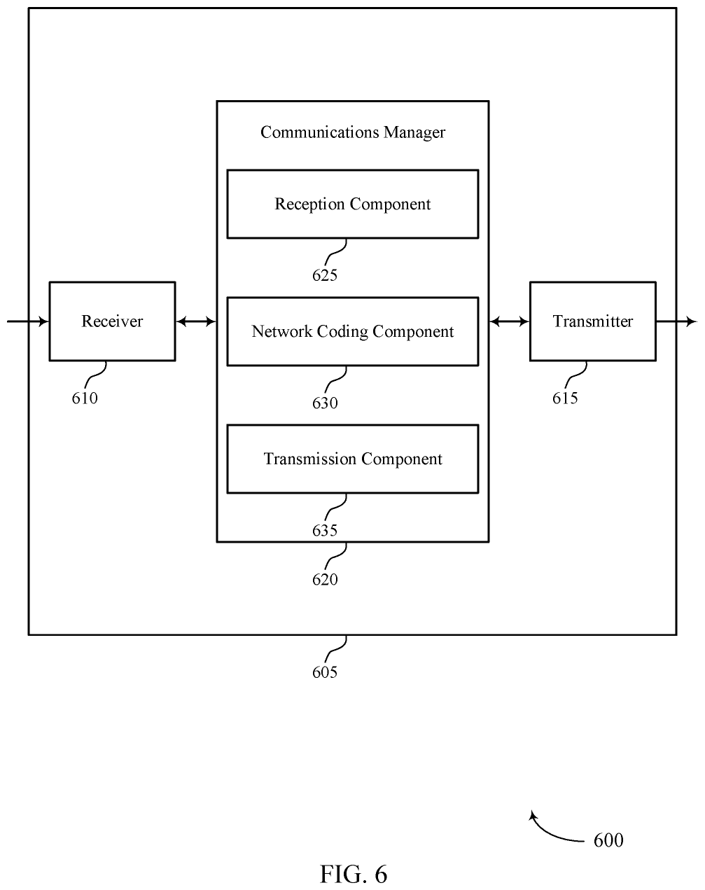

FIG. 6 shows a block diagram 600 of a device 605 that supports sidelink retransmission for broadcast data in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to sidelink retransmission for broadcast data). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to sidelink retransmission for broadcast data). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of sidelink retransmission for broadcast data as described herein. For example, the communications manager 620 may include a reception component 625, a network coding component 630, a transmission component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The reception component 625 may be configured as or otherwise support a means for receiving, as a broadcast from a base station, a set of multiple encoded packets associated with a set of multiple source packets representing a data set. The network coding component 630 may be configured as or otherwise support a means for attempting to recover the set of multiple source packets from the set of multiple encoded packets received from the base station. The transmission component 635 may be configured as or otherwise support a means for transmitting, to a second UE over a sidelink channel and based on failure by the UE to recover the set of multiple source packets representing the data set, a message requesting sidelink assistance in recovering the set of multiple source packets representing the data set.

Additionally or alternatively, the communications manager 620 may support wireless communication at a UE in accordance with examples as disclosed herein. The reception component 625 may be configured as or otherwise support a means for receiving, as a broadcast from a base station, a set of multiple encoded packets associated with a set of multiple source packets representing a data set. The reception component 625 may be configured as or otherwise support a means for receiving, from a second UE over a sidelink channel, a first message requesting sidelink assistance in recovering the set of multiple source packets. The transmission component 635 may be configured as or otherwise support a means for transmitting, to the second UE responsive to the first message, a second message indicative of an ability of the UE to assist the second UE with recovering the set of multiple source packets.

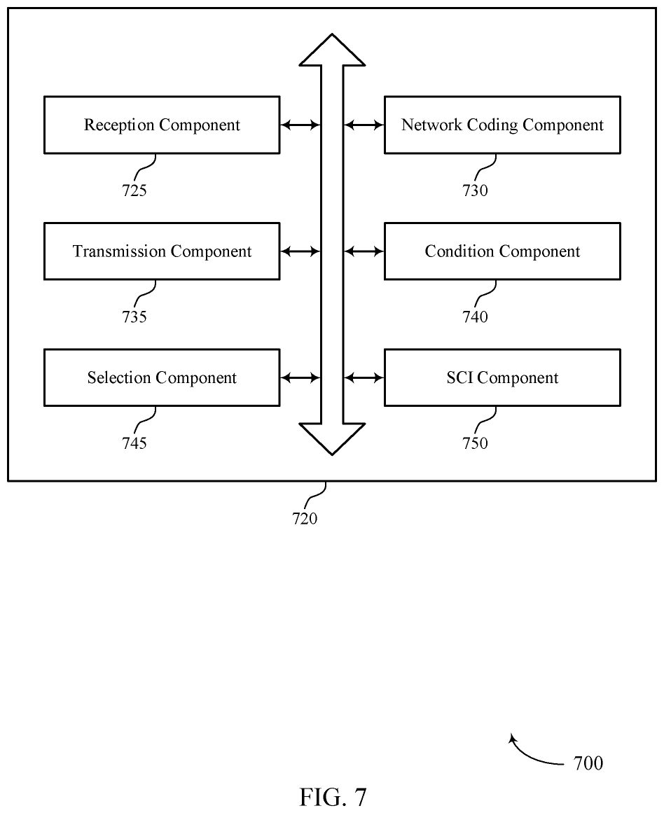

FIG. 7 shows a block diagram 700 of a communications manager 720 that supports sidelink retransmission for broadcast data in accordance with aspects of the present disclosure. The communications manager 720 may be an example of aspects of a communications manager 520, a communications manager 620, or both, as described herein. The communications manager 720, or various components thereof, may be an example of means for performing various aspects of sidelink retransmission for broadcast data as described herein. For example, the communications manager 720 may include a reception component 725, a network coding component 730, a transmission component 735, a condition component 740, a selection component 745, an SCI component 750, or any combination thereof. Each of these components may communicate, directly or indirectly, with one another (e.g., via one or more buses).

The communications manager 720 may support wireless communication at a UE in accordance with examples as disclosed herein. The reception component 725 may be configured as or otherwise support a means for receiving, as a broadcast from a base station, a set of multiple encoded packets associated with a set of multiple source packets representing a data set. The network coding component 730 may be configured as or otherwise support a means for attempting to recover the set of multiple source packets from the set of multiple encoded packets received from the base station. The transmission component 735 may be configured as or otherwise support a means for transmitting, to a second UE over a sidelink channel and based on failure by the UE to recover the set of multiple source packets representing the data set, a message requesting sidelink assistance in recovering the set of multiple source packets representing the data set.

In some examples, the network coding component 730 may be configured as or otherwise support a means for determining that the UE has failed to recover one or more encoded packets of the set of multiple encoded packets. In some examples, the transmission component 735 may be configured as or otherwise support a means for including, in the message, a request for the one or more encoded packets.

In some examples, the transmission component 735 may be configured as or otherwise support a means for including, in the message, an index associated with the data set and one or more indices corresponding to the one or more encoded packets.

In some examples, the transmission component 735 may be configured as or otherwise support a means for including, in the message, an index associated with the data set and a request for a quantity of encoded packets for recovering the set of multiple source packets.

In some examples, the message includes a network coding layer report associated with a network coding layer between a packet data convergence protocol layer and a radio link control layer.

In some examples, the reception component 725 may be configured as or otherwise support a means for receiving, from the second UE responsive to the message, one or more encoded packets associated with the set of multiple source packets. In some examples, the network coding component 730 may be configured as or otherwise support a means for recovering the set of multiple source packets based on receiving the one or more encoded packets.

In some examples, the SCI component 750 may be configured as or otherwise support a means for transmitting sidelink control information that schedules transmission, by the second UE, of the one or more encoded packets.

In some examples, the SCI component 750 may be configured as or otherwise support a means for receiving sidelink control information that schedules transmission, by the second UE, of the one or more encoded packets.

In some examples, to support recovering the set of multiple source packets, the network coding component 730 may be configured as or otherwise support a means for decoding the set of multiple encoded packets and the one or more encoded packets at a network coding layer which is between a packet data convergence protocol layer and radio link control layer in a protocol stack.

In some examples, to support transmitting the message requesting sidelink assistance, the transmission component 735 may be configured as or otherwise support a means for transmitting the message as a unicast transmission to the second UE. In some examples, to support transmitting the message requesting sidelink assistance, the reception component 725 may be configured as or otherwise support a means for receiving, from a third UE different from the second UE, responsive to the message, one or more encoded packets associated with the set of multiple source packets. In some examples, to support transmitting the message requesting sidelink assistance, the network coding component 730 may be configured as or otherwise support a means for recovering the set of multiple source packets based on receiving the one or more encoded packets.

In some examples, the condition component 740 may be configured as or otherwise support a means for determining a channel quality, a reference signal received power, or a combination thereof, for one or more UEs. In some examples, the selection component 745 may be configured as or otherwise support a means for selecting a subset of UEs from the one or more UEs to which the message is to be transmitted based on the channel quality, the reference signal received power, or the combination thereof.

In some examples, the reception component 725 may be configured as or otherwise support a means for receiving, from the second UE responsive to the message, a second message indicating that the second UE is not able to assist the UE with recovering the set of multiple source packets.

In some examples, the message is broadcast, groupcast, or unicast.

Additionally or alternatively, the communications manager 720 may support wireless communication at a UE in accordance with examples as disclosed herein. In some examples, the reception component 725 may be configured as or otherwise support a means for receiving, as a broadcast from a base station, a set of multiple encoded packets associated with a set of multiple source packets representing a data set. In some examples, the reception component 725 may be configured as or otherwise support a means for receiving, from a second UE over a sidelink channel, a first message requesting sidelink assistance in recovering the set of multiple source packets. In some examples, the transmission component 735 may be configured as or otherwise support a means for transmitting, to the second UE responsive to the first message, a second message indicative of an ability of the UE to assist the second UE with recovering the set of multiple source packets.

In some examples, the first message includes a request for one or more encoded packets associated with the set of multiple source packets, and the transmission component 735 may be configured as or otherwise support a means for including the one or more encoded packets in the second message.

In some examples, the first message includes an index associated with the data set and one or more indices corresponding to the one or more encoded packets.

In some examples, the first message includes an index associated with the data set and a request for a quantity of encoded packets for recovering the set of multiple source packets, and the transmission component 735 may be configured as or otherwise support a means for including the quantity of encoded packets in the second message.

In some examples, the network coding component 730 may be configured as or otherwise support a means for decoding the set of multiple encoded packets at a network coding layer which is between a packet data convergence protocol layer and radio link control layer in a protocol stack. In some examples, the network coding component 730 may be configured as or otherwise support a means for recovering the set of multiple source packets associated with the data set based on decoding the set of multiple encoded packets.

In some examples, the transmission component 735 may be configured as or otherwise support a means for including, in the second message, one or more encoded packets associated with the set of multiple source packets, where the one or more encoded packets are scheduled by sidelink control information included in the first message.

In some examples, the transmission component 735 may be configured as or otherwise support a means for including, in the second message, one or more encoded packets associated with the set of multiple source packets. In some examples, the transmission component 735 may be configured as or otherwise support a means for including, in the second message, sidelink control information that schedules transmission of the one or more encoded packets.

In some examples, the network coding component 730 may be configured as or otherwise support a means for determining that the UE has failed to recover the set of multiple source packets. In some examples, the transmission component 735 may be configured as or otherwise support a means for relaying the first message to a third UE based on determining that the UE failed to recover the set of multiple source packets, where the second message includes an indication of the relay.

In some examples, the reception component 725 may be configured as or otherwise support a means for receiving, from a third UE over the sidelink channel, a third message requesting sidelink assistance in recovering the set of multiple source packets, where the second message is groupcast to the second UE and the third UE based on the third message.

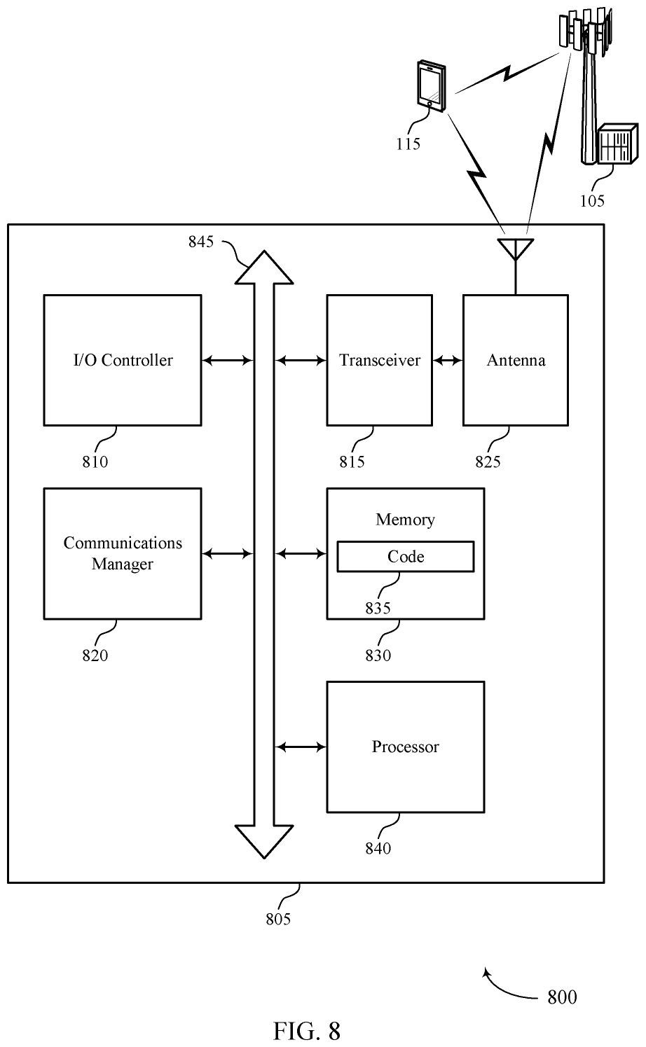

FIG. 8 shows a diagram of a system 800 including a device 805 that supports sidelink retransmission for broadcast data in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting sidelink retransmission for broadcast data). For example, the device 805 or a component of the device 805 may include a processor 840 and memory 830 coupled to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving, as a broadcast from a base station, a set of multiple encoded packets associated with a set of multiple source packets representing a data set. The communications manager 820 may be configured as or otherwise support a means for attempting to recover the set of multiple source packets from the set of multiple encoded packets received from the base station. The communications manager 820 may be configured as or otherwise support a means for transmitting, to a second UE over a sidelink channel and based on failure by the UE to recover the set of multiple source packets representing the data set, a message requesting sidelink assistance in recovering the set of multiple source packets representing the data set.

Additionally or alternatively, the communications manager 820 may support wireless communication at a UE in accordance with examples as disclosed herein. For example, the communications manager 820 may be configured as or otherwise support a means for receiving, as a broadcast from a base station, a set of multiple encoded packets associated with a set of multiple source packets representing a data set. The communications manager 820 may be configured as or otherwise support a means for receiving, from a second UE over a sidelink channel, a first message requesting sidelink assistance in recovering the set of multiple source packets. The communications manager 820 may be configured as or otherwise support a means for transmitting, to the second UE responsive to the first message, a second message indicative of an ability of the UE to assist the second UE with recovering the set of multiple source packets.

By including or configuring the communications manager 820 in accordance with examples as described herein, the device 805 may support techniques for improved communication reliability and more efficient use of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of sidelink retransmission for broadcast data as described herein, or the processor 840 and the memory 830 may be otherwise configured to perform or support such operations.

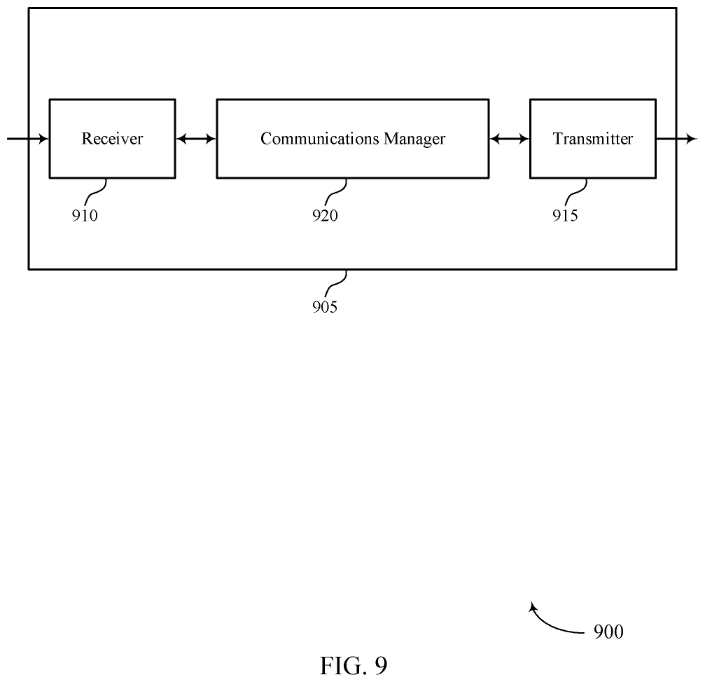

FIG. 9 shows a block diagram 900 of a device 905 that supports sidelink retransmission for broadcast data in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to sidelink retransmission for broadcast data). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to sidelink retransmission for broadcast data). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of sidelink retransmission for broadcast data as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a base station in accordance with examples as disclosed herein. For example, the communications manager 920 may be configured as or otherwise support a means for receiving a data set (e.g., formatted as a PDU) at a network coding layer. The communications manager 920 may be configured as or otherwise support a means for generating, at the network coding layer, a set of multiple source packets that represent the data set. The communications manager 920 may be configured as or otherwise support a means for encoding the multiple source packets at the network coding layer using network coding, where the encoding generates a set of multiple encoded packets from the set of multiple source packets. The communications manager 920 may be configured as or otherwise support a means for transmitting the set of multiple encoded packets in a broadcast.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for more efficient use of communication resources.

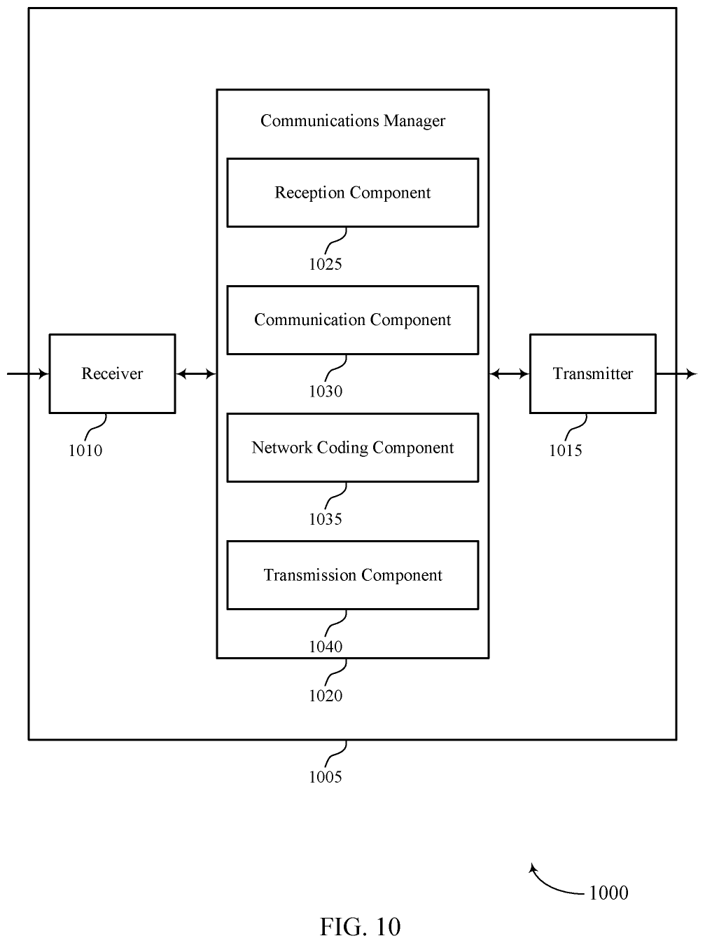

FIG. 10 shows a block diagram 1000 of a device 1005 that supports sidelink retransmission for broadcast data in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to sidelink retransmission for broadcast data). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to sidelink retransmission for broadcast data). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of sidelink retransmission for broadcast data as described herein. For example, the communications manager 1020 may include a reception component 1025, a communication component 1030, a network coding component 1035, a transmission component 1040, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a base station in accordance with examples as disclosed herein. The reception component 1025 may be configured as or otherwise support a means for receiving a data set (e.g., formatted as a PDU) at a network coding layer of a protocol stack. The communication component 1030 may be configured as or otherwise support a means for generating, at the network coding layer, multiple source packets that represent the data set. The network coding component 1035 may be configured as or otherwise support a means for encoding the multiple source packets at the network coding layer using network coding, where the encoding generates a set of multiple encoded packets from the set of multiple source packets. The transmission component 1040 may be configured as or otherwise support a means for transmitting the set of multiple encoded packets in a broadcast.

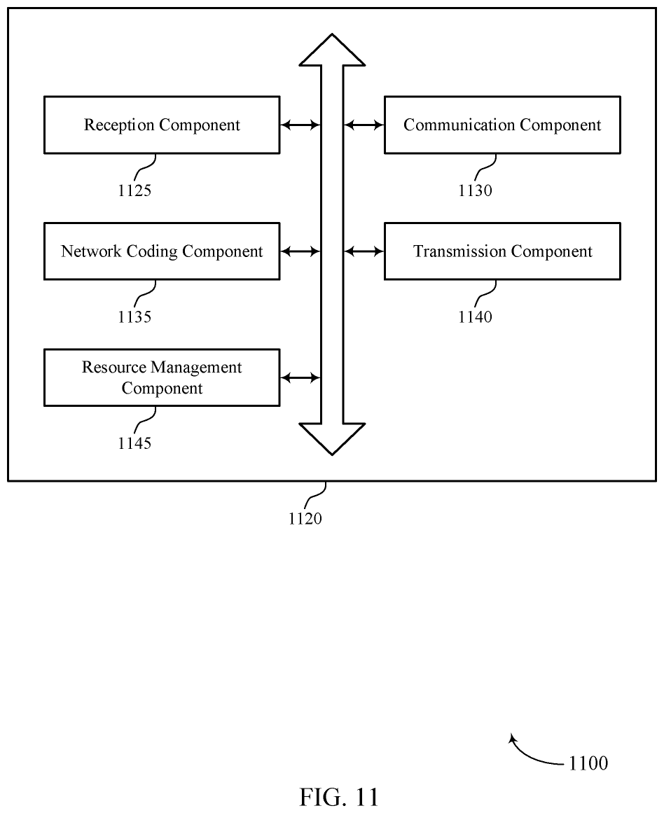

FIG. 11 shows a block diagram 1100 of a communications manager 1120 that supports sidelink retransmission for broadcast data in accordance with aspects of the present disclosure. The communications manager 1120 may be an example of aspects of a communications manager 920, a communications manager 1020, or both, as described herein. The communications manager 1120, or various components thereof, may be an example of means for performing various aspects of sidelink retransmission for broadcast data as described herein. For example, the communications manager 1120 may include a reception component 1125, a communication component 1130, a network coding component 1135, a transmission component 1140, a resource management component 1145, or any combination thereof. Each of these components may communicate, directly or indirectly, with one another (e.g., via one or more buses).

The communications manager 1120 may support wireless communication at a base station in accordance with examples as disclosed herein. The reception component 1125 may be configured as or otherwise support a means for receiving a data set at a network coding layer of a protocol stack. The communication component 1130 may be configured as or otherwise support a means for generating, at the network coding layer, multiple source packets that represent the data set. The network coding component 1135 may be configured as or otherwise support a means for encoding the multiple source packets at the network coding layer using network coding, where the encoding generates multiple encoded packets from the multiple source packets. The transmission component 1140 may be configured as or otherwise support a means for transmitting the set of multiple encoded packets in a broadcast.

In some examples, the network coding layer is a bottom sublayer of the packet data convergence protocol layer. In some examples, the network coding layer is a top sublayer of a radio link control layer. In some examples, the network coding layer is a layer below the packet data convergence protocol layer and above a radio link control layer.

In some examples, the resource management component 1145 may be configured as or otherwise support a means for allocating a first set of slots in a frame for the transmission of the set of multiple encoded packets. In some examples, the resource management component 1145 may be configured as or otherwise support a means for allocating a second set of slots in the frame for a re-transmission, by a UE over a sidelink channel, of one or more encoded packets of the set of multiple encoded packets of the data set.

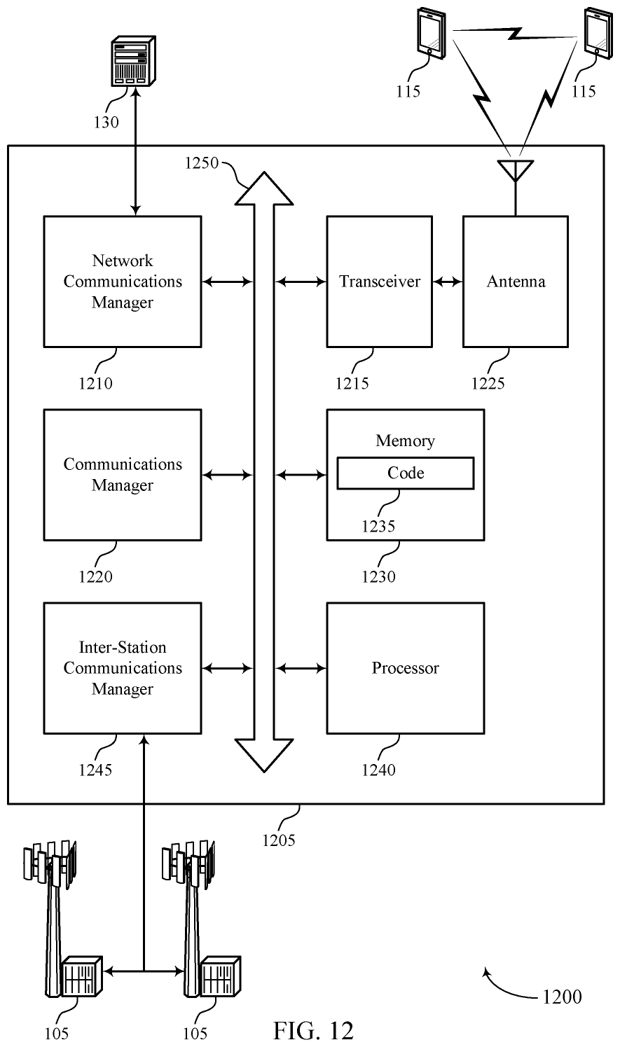

FIG. 12 shows a diagram of a system 1200 including a device 1205 that supports sidelink retransmission for broadcast data in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting sidelink retransmission for broadcast data). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communication at a base station in accordance with examples as disclosed herein. For example, the communications manager 1220 may be configured as or otherwise support a means for receiving a data set (e.g., in a PDU) at a network coding layer of a protocol stack. The communications manager 1220 may be configured as or otherwise support a means for generating, at the network coding layer, multiple source packets that represent the data set. The communications manager 1220 may be configured as or otherwise support a means for encoding the multiple source packets at the network coding layer using network coding, where the encoding generates multiple encoded packets from the set of multiple source packets. The communications manager 1220 may be configured as or otherwise support a means for transmitting the multiple encoded packets in a broadcast.

By including or configuring the communications manager 1220 in accordance with examples as described herein, the device 1205 may support techniques for improved communication reliability and more efficient use of communication resources.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of sidelink retransmission for broadcast data as described herein, or the processor 1240 and the memory 1230 may be otherwise configured to perform or support such operations.

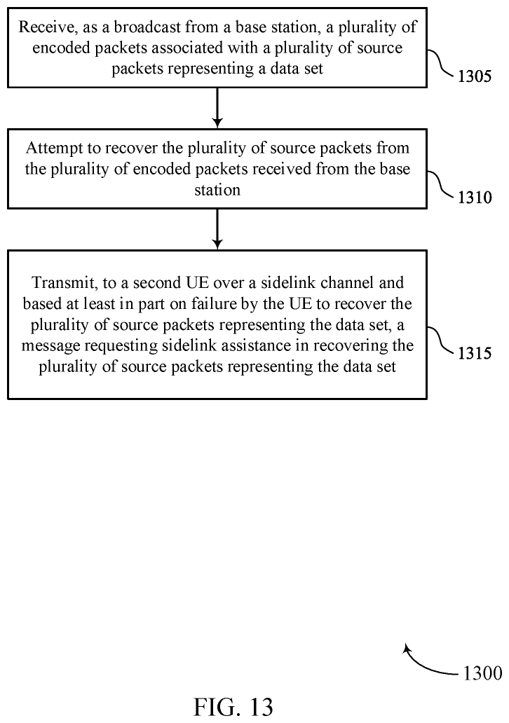

FIG. 13 shows a flowchart illustrating a method 1300 that supports sidelink retransmission for broadcast data in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving, as a broadcast from a base station, a set of multiple encoded packets associated with a set of multiple source packets representing a data set. The operations of 1305 may be performed in accordance with examples as disclosed herein. In some examples, aspects of the operations of 1305 may be performed by a reception component 725 as described with reference to FIG. 7.

At 1310, the method may include attempting to recover the set of multiple source packets from the set of multiple encoded packets received from the base station. The operations of 1310 may be performed in accordance with examples as disclosed herein. In some examples, aspects of the operations of 1310 may be performed by a network coding component 730 as described with reference to FIG. 7.

At 1315, the method may include transmitting, to a second UE over a sidelink channel and based on failure by the UE to recover the set of multiple source packets representing the data set, a message requesting sidelink assistance in recovering the set of multiple source packets representing the data set. The operations of 1315 may be performed in accordance with examples as disclosed herein. In some examples, aspects of the operations of 1315 may be performed by a transmission component 735 as described with reference to FIG. 7.

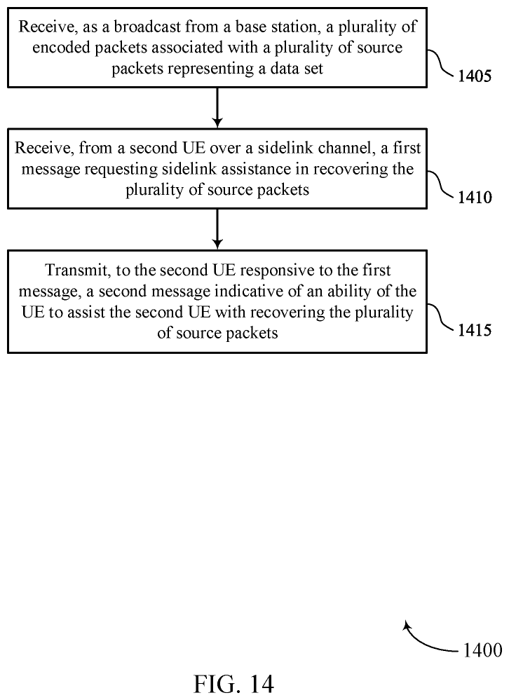

FIG. 14 shows a flowchart illustrating a method 1400 that supports sidelink retransmission for broadcast data in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving, as a broadcast from a base station, a set of multiple encoded packets associated with a set of multiple source packets representing a data set. The operations of 1405 may be performed in accordance with examples as disclosed herein. In some examples, aspects of the operations of 1405 may be performed by a reception component 725 as described with reference to FIG. 7.

At 1410, the method may include receiving, from a second UE over a sidelink channel, a first message requesting sidelink assistance in recovering the set of multiple source packets. The operations of 1410 may be performed in accordance with examples as disclosed herein. In some examples, aspects of the operations of 1410 may be performed by a reception component 725 as described with reference to FIG. 7.

At 1415, the method may include transmitting, to the second UE responsive to the first message, a second message indicative of an ability of the UE to assist the second UE with recovering the set of multiple source packets. The operations of 1415 may be performed in accordance with examples as disclosed herein. In some examples, aspects of the operations of 1415 may be performed by a transmission component 735 as described with reference to FIG. 7.

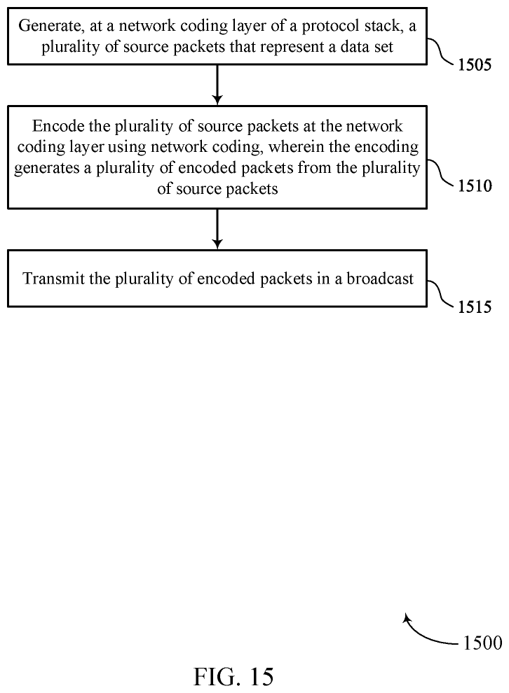

FIG. 15 shows a flowchart illustrating a method 1500 that supports sidelink retransmission for broadcast data in accordance with aspects of the present disclosure. The operations of the method 1500 may be implemented by a base station or its components as described herein. For example, the operations of the method 1500 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1505, the method may include generating, at a network coding layer of a protocol stack, a plurality of source packets that represent a data set. The operations of 1505 may be performed in accordance with examples as disclosed herein. In some examples, aspects of the operations of 1505 may be performed by a communication component 1130 as described with reference to FIG. 11.

At 1510, the method may include encoding the plurality of source packets at the network coding layer using network coding, wherein the encoding generates a plurality of encoded packets from the plurality of source packets. The operations of 1510 may be performed in accordance with examples as disclosed herein. In some examples, aspects of the operations of 1510 may be performed by a network coding component 1135 as described with reference to FIG. 11.

At 1515, the method may include transmitting the set of multiple encoded packets in a broadcast. The operations of 1515 may be performed in accordance with examples as disclosed herein. In some examples, aspects of the operations of 1515 may be performed by a transmission component 1140 as described with reference to FIG. 11.

The following provides an overview of aspects of the present disclosure:

Aspect 1: A method for wireless communication at a UE, comprising: receiving, as a broadcast from a base station, a plurality of encoded packets associated with a plurality of source packets representing a data set; attempting to recover the plurality of source packets from the plurality of encoded packets received from the base station; and transmitting, to a second UE over a sidelink channel and based at least in part on failure by the UE to recover the plurality of source packets representing the data set, a message requesting sidelink assistance in recovering the plurality of source packets representing the data set.

Aspect 2: The method of aspect 1, further comprising: determining that the UE has failed to recover one or more encoded packets of the plurality of encoded packets; and including, in the message, a request for the one or more encoded packets.

Aspect 3: The method of aspect 2, further comprising: including, in the message, an index associated with the data set and one or more indices corresponding to the one or more encoded packets.

Aspect 4: The method of any of aspects 1 through 2, further comprising: including, in the message, an index associated with the data set and a request for a quantity of encoded packets for recovering the plurality of source packets.

Aspect 5: The method of any of aspects 1 through 4, wherein the message comprises a network coding layer report associated with a network coding layer between a packet data convergence protocol layer and a radio link control layer.

Aspect 6: The method of any of aspects 1 through 5, further comprising: receiving, from the second UE responsive to the message, one or more encoded packets associated with the plurality of source packets; and recovering the plurality of source packets based at least in part on receiving the one or more encoded packets.

Aspect 7: The method of aspect 6, further comprising: transmitting sidelink control information that schedules transmission, by the second UE, of the one or more encoded packets.

Aspect 8: The method of aspect 6, further comprising: receiving sidelink control information that schedules transmission, by the second UE, of the one or more encoded packets.

Aspect 9: The method of any of aspects 6 through 8, wherein recovering the plurality of source packets comprises: decoding the plurality of encoded packets and the one or more encoded packets at a network coding layer which is between a packet data convergence protocol layer and radio link control layer in a protocol stack.

Aspect 10: The method of any of aspects 1 through 5, wherein transmitting the message requesting sidelink assistance further comprises: transmitting the message as a unicast transmission to the second UE; receiving, from a third UE different from the second UE, responsive to the message, one or more encoded packets associated with the plurality of source packets; and recovering the plurality of source packets based at least in part on receiving the one or more encoded packets.

Aspect 11: The method of any of aspects 1 through 10, further comprising: determining a channel quality, a reference signal received power, or a combination thereof, for one or more UEs; and selecting a subset of UEs from the one or more UEs to which the message is to be transmitted based at least in part on the channel quality, the reference signal received power, or the combination thereof.

Aspect 12: The method of any of aspects 1 through 5, 10, or 11, further comprising: receiving, from the second UE responsive to the message, a second message indicating that the second UE is not able to assist the UE with recovering the plurality of source packets.

Aspect 13: The method of any of aspects 1 through 12, wherein the message is broadcast, groupcast, or unicast.

Aspect 14: A method for wireless communication at a UE, comprising: receiving, as a broadcast from a base station, a plurality of encoded packets associated with a plurality of source packets representing a data set; receiving, from a second UE over a sidelink channel, a first message requesting sidelink assistance in recovering the plurality of source packets; and transmitting, to the second UE responsive to the first message, a second message indicative of an ability of the UE to assist the second UE with recovering the plurality of source packets.

Aspect 15: The method of aspect 14, wherein the first message includes a request for one or more encoded packets associated with the plurality of source packets, the method further comprising: including the one or more encoded packets in the second message.

Aspect 16: The method of aspect 15, wherein the first message includes an index associated with the data set and one or more indices corresponding to the one or more encoded packets.

Aspect 17: The method of any of aspect 14, wherein the first message includes an index associated with the data set and a request for a quantity of encoded packets for recovering the plurality of source packets, the method further comprising: including the quantity of encoded packets in the second message.

Aspect 18: The method of any of aspects 14 through 17, further comprising: decoding the plurality of encoded packets at a network coding layer which is between a packet data convergence protocol layer and radio link control layer in a protocol stack; and recovering the plurality of source packets associated with the data set based at least in part on decoding the plurality of encoded packets.

Aspect 19: The method of any of aspects 14 through 18, further comprising: including, in the second message, one or more encoded packets associated with the plurality of source packets, wherein the one or more encoded packets are scheduled by sidelink control information included in the first message.

Aspect 20: The method of any of aspects 14 through 18, further comprising: including, in the second message, one or more encoded packets associated with the plurality of source packets; and including, in the second message, sidelink control information that schedules transmission of the one or more encoded packets.

Aspect 21: The method of aspect 14, further comprising: determining that the UE has failed to recover the plurality of source packets; and relaying the first message to a third UE based at least in part on determining that the UE failed to recover the plurality of source packets, wherein the second message comprises an indication of the relay.

Aspect 22: The method of any of aspects 14 through 21, further comprising: receiving, from a third UE over the sidelink channel, a third message requesting sidelink assistance in recovering the plurality of source packets, wherein the second message is groupcast to the second UE and the third UE based at least in part on the third message.

Aspect 23: A method for wireless communication at a base station, comprising: generating, at a network coding layer of a protocol stack, a plurality of source packets that represent a data set; encoding the plurality of source packets at the network coding layer using network coding, wherein the encoding generates a plurality of encoded packets from the plurality of source packets; and transmitting the plurality of encoded packets in a broadcast.

Aspect 24: The method of aspect 23, wherein the network coding layer is a bottom sublayer of a packet data convergence protocol layer.

Aspect 25: The method of aspect 23, wherein the network coding layer is a top sublayer of a radio link control layer.

Aspect 26: The method of aspect 23, wherein the network coding layer is a layer below a packet data convergence protocol layer and above a radio link control layer.

Aspect 27: The method of any of aspects 23 through 26, further comprising: allocating a first set of slots in a frame for the transmission of the plurality of encoded packets; and allocating a second set of slots in the frame for a re-transmission, by a UE over a sidelink channel, of one or more encoded packets of the plurality of encoded packets of the data set.

Aspect 28: An apparatus for wireless communication at a UE, comprising a processor; memory coupled with the processor; and instructions stored in the memory and executable by the processor to cause the apparatus to perform a method of any of aspects 1 through 13.

Aspect 29: An apparatus for wireless communication at a UE, comprising at least one means for performing a method of any of aspects 1 through 13.

Aspect 30: A non-transitory computer-readable medium storing code for wireless communication at a UE, the code comprising instructions executable by a processor to perform a method of any of aspects 1 through 13.

Aspect 31: An apparatus for wireless communication at a UE, comprising a processor; memory coupled with the processor; and instructions stored in the memory and executable by the processor to cause the apparatus to perform a method of any of aspects 14 through 22.

Aspect 32: An apparatus for wireless communication at a UE, comprising at least one means for performing a method of any of aspects 14 through 22.

Aspect 33: A non-transitory computer-readable medium storing code for wireless communication at a UE, the code comprising instructions executable by a processor to perform a method of any of aspects 14 through 22.

Aspect 34: An apparatus for wireless communication at a base station, comprising a processor; memory coupled with the processor; and instructions stored in the memory and executable by the processor to cause the apparatus to perform a method of any of aspects 23 through 27.

Aspect 35: An apparatus for wireless communication at a base station, comprising at least one means for performing a method of any of aspects 23 through 27.

Aspect 36: A non-transitory computer-readable medium storing code for wireless communication at a base station, the code comprising instructions executable by a processor to perform a method of any of aspects 23 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, as a broadcast from a base station, a plurality of encoded packets associated with a plurality of source packets representing a data set;
attempting to recover the plurality of source packets from the plurality of encoded packets received from the base station; and
transmitting, to a second UE over a sidelink channel and based at least in part on failure by the UE to recover the plurality of source packets representing the data set, a message requesting sidelink assistance in recovering the plurality of source packets representing the data set.

2. The method of claim 1, further comprising:
determining that the UE has failed to recover one or more encoded packets of the plurality of encoded packets; and
including, in the message, a request for the one or more encoded packets.

3. The method of claim 2, further comprising:
including, in the message, an index associated with the data set and one or more indices corresponding to the one or more encoded packets.

4. The method of claim 1, further comprising:
including, in the message, an index associated with the data set and a request for a quantity of encoded packets for recovering the plurality of source packets.

5. The method of claim 1, wherein the message comprises a network coding layer report associated with a network coding layer between a packet data convergence protocol layer and a radio link control layer.

6. The method of claim 1, further comprising:
receiving, from the second UE responsive to the message, one or more encoded packets associated with the plurality of source packets; and
recovering the plurality of source packets based at least in part on receiving the one or more encoded packets.

7. The method of claim 6, further comprising:
transmitting sidelink control information that schedules transmission, by the second UE, of the one or more encoded packets.

8. The method of claim 6, further comprising:
receiving sidelink control information that schedules transmission, by the second UE, of the one or more encoded packets.

9. The method of claim 6, wherein recovering the plurality of source packets comprises:
decoding the plurality of encoded packets and the one or more encoded packets at a network coding layer which is between a packet data convergence protocol layer and radio link control layer in a protocol stack.

10. The method of claim 1, wherein transmitting the message requesting sidelink assistance further comprises:
transmitting the message as a unicast transmission to the second UE, the method further comprising;
receiving, from a third UE different from the second UE, responsive to the message, one or more encoded packets associated with the plurality of source packets; and
recovering the plurality of source packets based at least in part on receiving the one or more encoded packets.

11. The method of claim 1, further comprising:
determining a channel quality, a reference signal received power, or a combination thereof, for one or more UEs; and
selecting a subset of UEs from the one or more UEs to which the message is to be transmitted based at least in part on the channel quality, the reference signal received power, or the combination thereof.

12. The method of claim 1, further comprising:
receiving, from the second UE responsive to the message, a second message indicating that the second UE is not able to assist the UE with recovering the plurality of source packets.

13. The method of claim 1, wherein the message is broadcast, groupcast, or unicast.

14. A method for wireless communication at a user equipment (UE), comprising:
receiving, as a broadcast from a base station, a plurality of encoded packets associated with a plurality of source packets representing a data set;
receiving, from a second UE over a sidelink channel, a first message requesting sidelink assistance in recovering the plurality of source packets; and
transmitting, to the second UE responsive to the first message, a second message indicative of an ability of the UE to assist the second UE with recovering the plurality of source packets.

15. The method of claim 14, wherein the first message includes a request for one or more encoded packets associated with the plurality of source packets, the method further comprising:
including the one or more encoded packets in the second message.

16. The method of claim 15, wherein the first message includes an index associated with the data set and one or more indices corresponding to the one or more encoded packets.

17. The method of claim 14, wherein the first message includes an index associated with the data set and a request for a quantity of encoded packets for recovering the plurality of source packets, the method further comprising:
including the quantity of encoded packets in the second message.

18. The method of claim 14, further comprising:
decoding the plurality of encoded packets at a network coding layer which is between a packet data convergence protocol layer and radio link control layer in a protocol stack; and
recovering the plurality of source packets associated with the data set based at least in part on decoding the plurality of encoded packets.

19. The method of claim 14, further comprising:
including, in the second message, one or more encoded packets associated with the plurality of source packets, wherein the one or more encoded packets are scheduled by sidelink control information included in the first message.

20. The method of claim 14, further comprising:
including, in the second message, one or more encoded packets associated with the plurality of source packets; and
including, in the second message, sidelink control information that schedules transmission of the one or more encoded packets.

21. The method of claim 14, further comprising:
determining that the UE has failed to recover the plurality of source packets; and
relaying the first message to a third UE based at least in part on determining that the UE failed to recover the plurality of source packets, wherein the second message comprises an indication of the relay.

22. The method of claim 14, further comprising:
receiving, from a third UE over the sidelink channel, a third message requesting sidelink assistance in recovering the plurality of source packets, wherein the second message is groupcast to the second UE and the third UE based at least in part on the third message.

23. A method for wireless communication at a base station, comprising:
generating, at a network coding layer of a protocol stack, a plurality of source packets that represent a data set;
encoding the plurality of source packets at the network coding layer using network coding, wherein the encoding generates a plurality of encoded packets from the plurality of source packets; and
transmitting the plurality of encoded packets in a broadcast.

24. The method of claim 23, wherein the network coding layer is a bottom sublayer of a packet data convergence protocol layer.

25. The method of claim 23, wherein the network coding layer is a top sublayer of a radio link control layer.

26. The method of claim 23, wherein the network coding layer is a layer below a packet data convergence protocol layer and above a radio link control layer.

27. The method of claim 23, further comprising:
allocating a first set of slots in a frame for the transmission of the plurality of encoded packets; and
allocating a second set of slots in the frame for a re-transmission, by a user equipment (UE) over a sidelink channel, of one or more encoded packets of the plurality of encoded packets of the data set.

28. An apparatus for wireless communication at a user equipment (UE), comprising:
a processor;
memory coupled with the processor; and
instructions stored in the memory and executable by the processor to cause the apparatus to:
receive, as a broadcast from a base station, a plurality of encoded packets associated with a plurality of source packets representing a data set;
attempt to recover the plurality of source packets from the plurality of encoded packets received from the base station; and
transmit, to a second UE over a sidelink channel and based at least in part on failure by the UE to recover the plurality of source packets representing the data set, a message requesting sidelink assistance in recovering the plurality of source packets representing the data set.

29. The apparatus of claim 28, wherein the instructions are further executable by the processor to cause the apparatus to:
determine that the UE has failed to recover one or more encoded packets of the plurality of encoded packets; and
include, in the message, a request for the one or more encoded packets.

30. The apparatus of claim 28, wherein the instructions are further executable by the processor to cause the apparatus to:
include, in the message, an index of the data set and one or more indices corresponding to the one or more encoded packets.
